(19) United States
(12) Patent Application Publication
(10) Pub. No.: US 2019/0365138 A1
(43) Pub. Date: Dec. 5, 2019

(54) High-pressure Centrifugal Intelligent Fast Filter Drip Coffee Maker

(71) Applicant: Chun Sing Andy YEUNG, Hong Kong (HK)

(72) Inventor: Chun Sing Andy YEUNG, Hong Kong (HK)

(21) Appl. No.: 16/108,085

(22) Filed: Aug. 21, 2018

(30) Foreign Application Priority Data
Jun. 2, 2018 (CN) 201810633303.5

(51) Int. Cl. A47J 31/22; A47J 31/06; A47J 31/36; A47J 31/52; A47J 31/58; G01J 5/00; G01J 5/02

(52) U.S. Cl. CPC A47J 31/22; A47J 31/0657; A47J 31/36; G01J 5/0275; A47J 31/58; G01J 5/0025; A47J 31/5255

(57) ABSTRACT

The invention relates to a high-pressure centrifugal intelligent fast filter drip coffee maker which includes an adjustable bracket and a centrifugal filter drip element. The adjustable bracket includes a bottom plate, a pillar fixedly disposed on the bottom plate, a first support plate, and a second support plate. The upper end of the pillar is provided with a cavity with an upward opening. A first motor, a lead screw, and a bearing are respectively arranged in the cavity. The lower end of the pillar is provided with a plurality of adjusting screw holes. The first support plate is fixedly connected to the adjusting screw hole by a bolt. A second motor is embedded in the first support plate. A main shaft of the second motor passes through the first support plate. The main shaft of the second motor is provided with a transmission gear. The centrifugal filter drip element includes a tank body, a rotating base, a cover, a water pump, a funnel and a water pipe. The high-pressure centrifugal intelligent fast filter drip coffee maker of the invention has advantages of having a simple and reasonable structure, being convenient to use, rapid brewing, safe and reliable, and good effect of brewing, etc. which effectively solves the problem of existing filter drip coffee makers making coffee slowly.

### FIELD OF THE INVENTION

The invention relates to a coffee maker. In particular, the invention relates to a high-pressure centrifugal intelligent fast filter drip coffee maker.

### BACKGROUND

Nowadays, there are basically three types of coffee makers, i.e. instant type, filter drip type, boiling type. The principle of making filter drip coffee is that the components in the coffee are extracted by hot water that slowly flows through coffee power under normal pressure so that the concentrated filter drip coffee with a good aroma and strong taste is finally made. Although the filter drip coffee is delicious, for all kinds of filter drip coffee makers, the essence of the coffee cannot be fully extracted due to the insufficient time of the hot water staying in the coffee powder because when the coffee is brewed, the boiling water leaks immediately after flowing through the coffee power under normal pressure. Therefore, the filter drip coffee is slightly less tasteful than cooked coffee. Despite this, the time required to brew coffee using a filter drip coffee maker is still longer than that of the instant type and boiling type because of the small capacity of filter drip coffee maker. The amount of brewing coffee per shot is not as much as that of the instant type and boiling type. Therefore, it is necessary to develop a high-pressure centrifugal intelligent fast filter drip coffee maker to reduce the time required for brewing coffee and meet the demand for a large amount of brewing coffee.

### SUMMARY OF THE INVENTION

The technical problem to be solved is to overcome the above-mentioned deficiency by providing a high-pressure centrifugal intelligent fast filter drip coffee maker. It has advantages of having a simple and reasonable structure, being convenient to use, rapid brewing, safe and reliable, and good effect of brewing, etc. which effectively solves the problem of existing filter drip coffee makers making coffee slowly.

The technical solution of the invention is to provide a high-pressure centrifugal intelligent fast filter drip coffee maker which includes an adjustable bracket, and a centrifugal filter drip element. The adjustable bracket includes a bottom plate, a pillar fixedly disposed on the bottom plate, a first support plate disposed on the pillar, and a second support plate.

The upper end of the pillar is provided with a cavity with an upward opening. A first motor, a lead screw, and a bearing are respectively arranged in the cavity from top to bottom. The first motor and the bearing are respectively fixedly connected with the inner wall of the cavity. The upper end of the lead screw is drivingly connected with the first motor. The lower end of the lead screw is drivingly connected with the bearing. The cavity is vertically disposed with an opening communicating with the outside.

The lower end of the pillar is provided with a plurality of adjusting screw holes. The first support plate is fixedly connected to the adjusting screw hole by a bolt. One end of the first support plate is provided with a first through hole sleeved with the pillar. The other end of the first support plate is provided with a circular notch. A plurality of positioning rods are disposed around the notch. A second motor is embedded in the first support plate. A main shaft of the second motor passes through the first support plate. The main shaft of the second motor is provided with a transmission gear.

The second support plate includes a sliding block and a protruding plate connected to the sliding block. The sliding block is slidably connected to the cavity. The sliding block is provided with a threaded hole which is screwed to the head screw. The protruding plate protrudes from the opening and is provided with a second through hole.

The centrifugal filter drip element includes a tank body, a rotating base, a cover, a water pump, a funnel and a water pipe which is sleeved with the second through hole. The cavity of the tank body is provided with a filter element. The lower end of the tank body is provided with a convex ring with a semicircular groove on both sides. The bottom of the tank body is provided with a third through hole and an inner gear ring that is drivingly connected to the transmission gear. The filter element includes a stencil with a circular structure, and a drum made of the rolled stencil. The drum and the stencil are connected to each other. The filter is evenly arranged on the inner wall of the drum cavity.

The rotating base includes an upper ring with an inverted L-shaped structure, and a lower ring sleeved with the upper ring. The upper ring and the lower ring are respectively provided with a first ring groove and a second ring groove. The first ring groove and the second ring groove are respectively slidably connected with the ball disposed between the semicircular grooves on the convex ring. The upper ring and the lower ring are screwed to each other. The lower ring is provided with a plurality of connecting holes that connect to the positioning rods.

The water pump is connected to the upper end of the water pipe. The cover is sleeved with the lower end of the water pipe. An inlet end of the funnel is fixedly connected with the tank body.

In a further embodiment, the upper surface of the bottom plate is provided with a tempered glass plate and an infrared distance sensor is embedded under the tempered glass plate.

In a further embodiment, the first support plate is provided with a microcontroller, and the micro controller is electrically connected to the infrared distance sensor, the first motor and the second motor respectively.

In a further embodiment, the opening of the upper end of the cavity is provided with an end cap screwed to the pillar.

In a further embodiment, the sliding block and the protruding plate are one-piece structure.

In a further embodiment, the drum is used to place coffee power. The lower end of the water pipe is fixedly sleeved with the filter, and inserted into the drum to contact with the coffee power.

In a further embodiment, the funnel is made of carbon structural steel. An outlet of the funnel is provided with a magnetic plug. The magnetic plug is connected with a rod member, and the middle of the rod member is hinged to the funnel.

In a further embodiment, the water pump draws hot water from the outside through a pipe.

In a further embodiment, the water pipe is provided with a flow sensor electrically connected to the microcontroller.

The technical effect of the invention is to provide a high-pressure centrifugal intelligent fast filter drip coffee maker which includes an adjustable bracket and a centrifugal filter drip element. The adjustable bracket controls the operation of the first motor and the second motor through the microcontroller. The adjustable bracket detects the distance between the user and the rotating tank body through the infrared distance sensor and whether a cup is placed under the coffee outlet to avoid injury. The filter drip coffee maker with a degree of high intelligence adopts an adjustable design and is applicable to cups of various heights. The centrifugal filter drip element accelerates the extraction of the coffee components by increasing the pressure and the temperature in the tank body, and accelerates the brewing and the filtration of coffee by centrifugation caused by the rotation of the tank body. It has advantages of having a simple and reasonable structure, being convenient to use, rapid brewing, safe and reliable, and good effect of brewing, etc. which effectively solves the problem of existing filter drip coffee makers making coffee slowly.

### BRIEF DESCRIPTION OF THE DRAWINGS

The invention is illustrated by the following figures and embodiments.

FIG. 1 shows a schematic diagram of whole structure of a high-pressure centrifugal intelligent fast filter drip coffee maker in accordance with one embodiment.

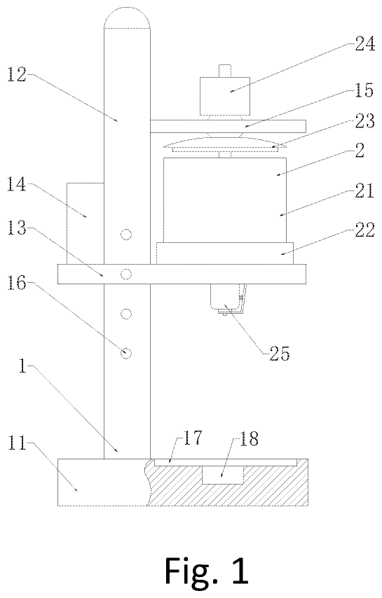

FIG. 2 shows a schematic diagram of a connection between an adjustable bracket and a centrifugal filter drip element of a high-pressure centrifugal intelligent fast filter drip coffee maker in accordance with one embodiment.

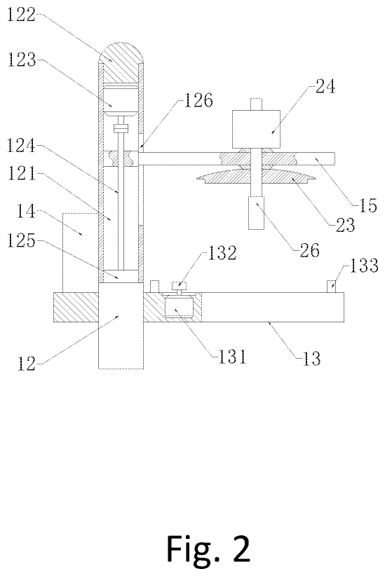

FIG. 3 shows a schematic diagram of a first support plate of a high-pressure centrifugal intelligent fast filter drip coffee maker in accordance with one embodiment.

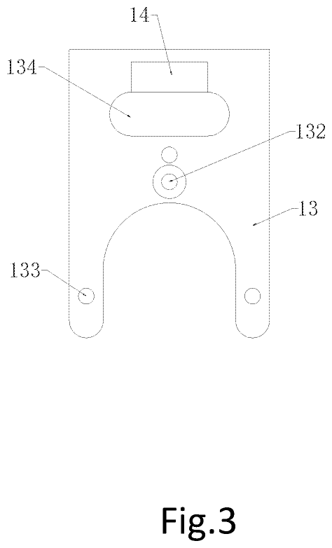

FIG. 4 shows a schematic diagram of a second support plate of a high-pressure centrifugal intelligent fast filter drip coffee maker in accordance with one embodiment.

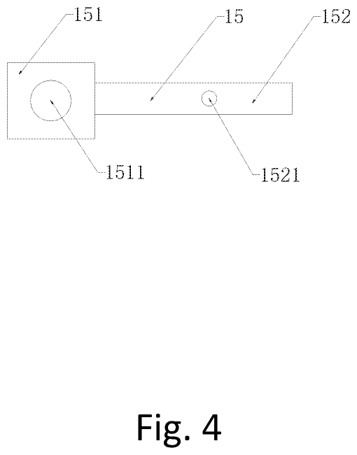

FIG. 5 shows a schematic diagram of a connection between a tank body, a rotating base and a funnel of a high-pressure centrifugal intelligent fast filter drip coffee maker in accordance with one embodiment.

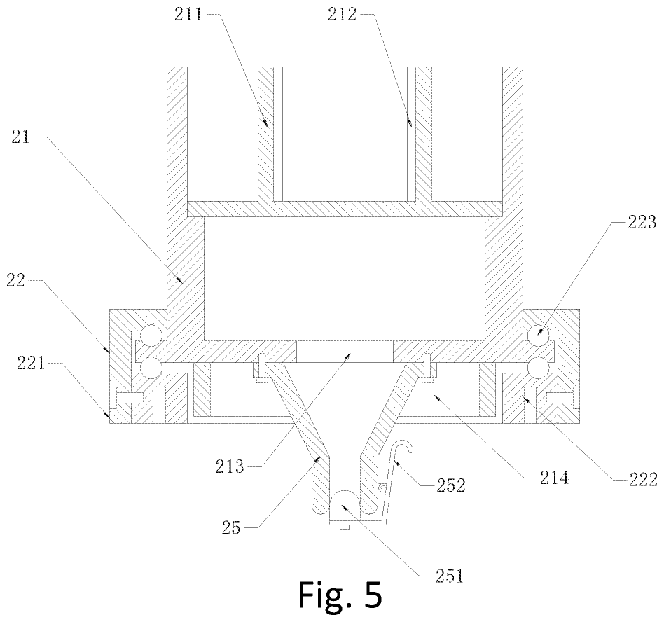

FIG. 6 shows a schematic diagram of a tank body of a high-pressure centrifugal intelligent fast filter drip coffee maker in accordance with one embodiment.

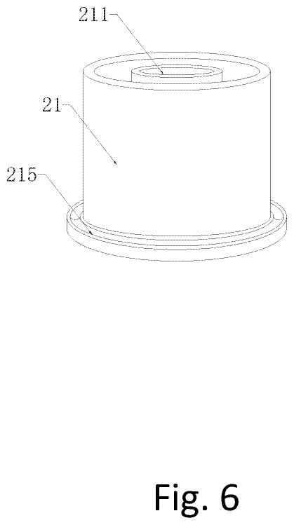

FIG. 7 shows a schematic diagram of an upper ring of a high-pressure centrifugal intelligent fast filter drip coffee maker in accordance with one embodiment.

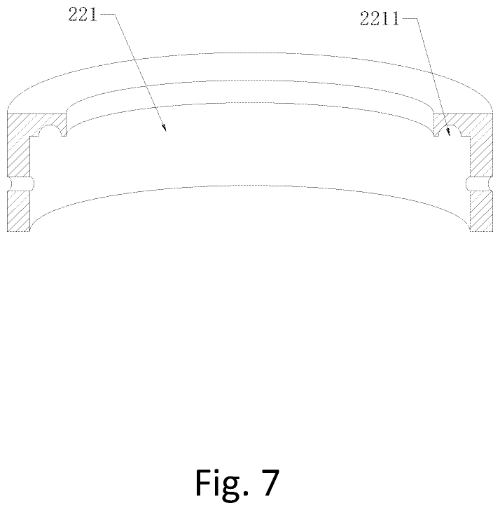

FIG. 8 shows a schematic diagram of a lower ring of a high-pressure centrifugal intelligent fast filter drip coffee maker in accordance with one embodiment.

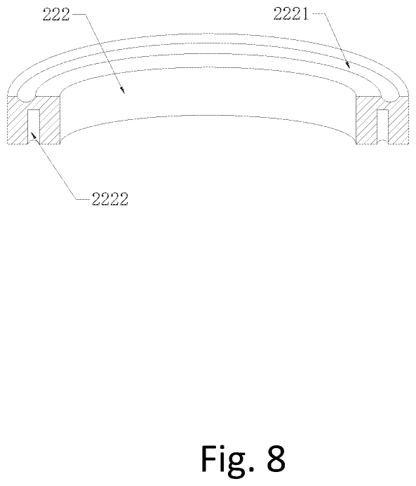

FIG. 9 shows a schematic diagram of a filter element of a high-pressure centrifugal intelligent fast filter drip coffee maker in accordance with one embodiment.

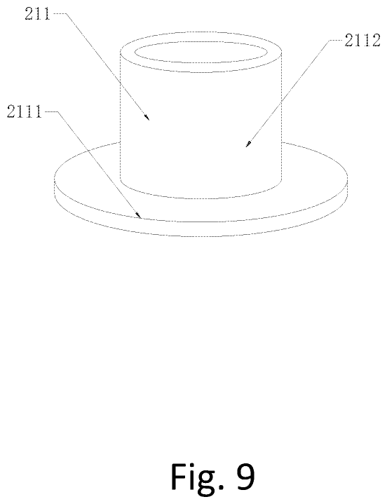

The reference numbers of the figures are as follows:

1: adjustable bracket; 11: bottom plate; 12: pillar: 121: cavity; 122: end cap; 123: first motor; 124: head screw; 125: bearing; 126: opening; 13: first support plate; 131: second motor; 132: transmission gear; 133: positioning rod; 134: first through hole; 14: microcontroller; 15: second support plate; 151: sliding block; 1511: threaded hole; 152: protruding plate; 1521: second through hole; 16: adjusting screw hole; 17: tempered glass plate; 18: infrared distance sensor; 2: centrifugal filter drip element; 21: tank body; 211: filter element; 2111: stencil; 2112: drum; 2211: first ring groove; 212: filter; 213: third through hole; 214: inner gear ring; 215: convex ring; 22: rotating base; 221: upper ring; 222: lower ring; 2221: second ring groove; 2222: connecting hole; 223: ball; 23: cover; 24: water pump; 25: funnel; 251: magnetic plug; 252: rod member; 26: water pipe.

What is claimed is:

1. A high-pressure centrifugal intelligent fast filter drip coffee maker comprising: an adjustable bracket 1, and a centrifugal filter drip element 2, wherein the adjustable bracket 1 includes a bottom plate 11 used to place a cup, a pillar 12 fixedly disposed on the bottom plate 11, a first support plate 13 disposed on the pillar 12, and a second support plate 15,
wherein the upper end of the pillar 12 is provided with a cavity 121 with an upward opening; a first motor 123, a lead screw 124, and a bearing 125 are respectively arranged in the cavity 121 from top to bottom; the first motor 123 and the bearing 125 are respectively fixedly connected with the inner wall of the cavity 121; the upper end of the lead screw 124 is drivingly connected with the first motor 123; the lower end of the lead screw 124 is drivingly connected with the bearing 125; the cavity 121 is vertically disposed with an opening 126 communicating with the outside,
wherein the lower end of the pillar 12 is provided with a plurality of adjusting screw holes 16; the first support plate 13 is fixedly connected to the adjusting screw hole 16 by a bolt; one end of the first support plate 13 is provided with a first through hole 134 sleeved with the pillar 12; the other end of the first support plate 13 is provided with a circular notch; a plurality of positioning rods 133 are disposed around the notch; a second motor 131 is embedded in the first support plate 13; a main shaft of the second motor 131 passes through the first support plate 13; the main shaft of the second motor 131 is provided with a transmission gear 132,
wherein the second support plate 15 includes a sliding block 151 and a protruding plate 152 connected to the sliding block 151; the sliding block 151 is slidably connected to the cavity 121; the sliding block 151 is provided with a threaded hole 1511 which is screwed to the head screw 124; the protruding plate 152 protrudes from the opening 126 and is provided with a second through hole 1521,
wherein the centrifugal filter drip element 2 includes a tank body 21, a rotating base 22, a cover 23, a water pump 24, a funnel 25 and a water pipe 26 which is sleeved with the second through hole 1521; the cavity of the tank body 21 is provided with a filter element 211; the lower end of the tank body 21 is provided with a convex ring 215 with a semicircular groove on both sides; the bottom of the tank body 21 is provided with a third through hole 213 and an inner gear ring 214 that is drivingly connected to the transmission gear 132; the filter element 211 includes a stencil 2111 with a circular structure, and a drum 2112 made of the rolled stencil; the drum 2112 and the stencil 2111 are connected to each other; the filter 212 is evenly arranged on the inner wall of the drum 2112 cavity,
wherein the rotating base 22 includes an upper ring 221 with an inverted L-shaped structure, and a lower ring 222 sleeved with the upper ring 221; the upper ring 221 and the lower ring 222 are respectively provided with a first ring groove 2211 and a second ring groove 2221; the first ring groove 2211 and the second ring groove 2221 are respectively slidably connected with the ball 223 disposed between the semicircular grooves on the convex ring 215; the upper ring 221 and the lower ring 222 are screwed to each other; the lower ring 222 is provided with a plurality of connecting holes 2222 that connect to the positioning rods 133,
wherein the water pump 24 is connected to the upper end of the water pipe 26; the cover 23 is sleeved with the lower end of the water pipe 26; an inlet end of the funnel 25 is fixedly connected with the tank body 21.

2. The high-pressure centrifugal intelligent fast filter drip coffee of claim 1, wherein the upper surface of the bottom plate 11 is provided with a tempered glass plate 17 and an infrared distance sensor 18 is embedded under the tempered glass plate 17.

3. The high-pressure centrifugal intelligent fast filter drip coffee of claim 1, wherein the first support plate 13 is provided with a microcontroller 14, and the micro controller 14 is electrically connected to the infrared distance sensor 18, the first motor 123 and the second motor 131 respectively.

4. The high-pressure centrifugal intelligent fast filter drip coffee of claim 1, wherein the opening of the upper end of the cavity 121 is provided with an end cap 122 screwed to the pillar 12.

5. The high-pressure centrifugal intelligent fast filter drip coffee of claim 1, wherein the sliding block 151 and the protruding plate 152 are one-piece structure.

6. The high-pressure centrifugal intelligent fast filter drip coffee of claim 1, wherein the drum 2112 is used for placing coffee powder, and the lower end of the water pipe 26 is fixedly sleeved and inserted into the drum 2112 to be in contact with the coffee powder.

7. The high-pressure centrifugal intelligent fast filter drip coffee of claim 1, wherein the funnel 25 is made of carbon structural steel; an outlet of the funnel 25 is provided with a magnetic plug 251; the magnetic plug 251 is connected with a rod member 252, and the middle of the rod member 252 is hinged to the funnel 25.

8. The high-pressure centrifugal intelligent fast filter drip coffee of claim 1, wherein the water pump 24 draws hot water from the outside through a pipe.

9. The high-pressure centrifugal intelligent fast filter drip coffee of claim 1, wherein the water pipe 26 is provided with a flow sensor electrically connected to the microcontroller 14.
